(19) United States
(12) Patent Application Publication
(10) Pub. No.: US 2019/0170077 A1
(43) Pub. Date: Jun. 6, 2019

(54) COMBUSTION CONTROL METHOD AND COMBUSTION CONTROL SYSTEM WITH VARIABLE EXCESS AIR COEFFICIENT FOR GASOLINE ENGINE

(71) Applicant: GUANGZHOU AUTOMOBILE GROUP CO., LTD., Guangzhou, Guangdong (CN)

(72) Inventors: Hong CHEN, Guangzhou (CN); Yuhuai LI, Guangzhou (CN); Jujiang LIU, Guangzhou (CN); Wenfeng ZHAN, Guangzhou (CN); Sicong LIN, Guangzhou (CN)

(73) Assignee: Guangzhou Automobile Group Co., Ltd., Guangzhou, Guangdong (CN)

(21) Appl. No.: 16/304,700

(22) PCT Filed: Sep. 28, 2017
(86) PCT No.: PCT/CN2017/103980

§ 371 Date: Nov. 27, 2018

(30) Foreign Application Priority Data
Sep. 30, 2016 (CN) 201610880511.6

(51) Int. Cl. F02D 41/18; F02D 11/10; F02P 5/04

(52) U.S. Cl. CPC F02D 41/182; F02D 11/105; F02D 2200/0414; F02D 2200/0402; F02P 5/045

(57) ABSTRACT

A combustion control method and a combustion control system with variable excess air coefficient for gasoline engine are provided. The combustion control method with variable excess air coefficient for gasoline engine comprises steps as follows: monitoring engine operating condition; determining current engine load condition based on the engine operating condition, wherein the engine load condition comprises part load, high load, and full load conditions; and selecting an appropriate excess air coefficient combustion mode in accordance with the current engine load condition; wherein the engine uses lean combustion mode with excess air coefficient of 1.6˜2.0 when the current engine load condition is the part load condition; the engine uses combustion mode with excess air coefficient of 1 when the current engine load condition is the high load condition; and the engine uses combustion mode with excess air coefficient of 0.8˜0.9 when the current engine load condition is the full load condition.

### CROSS REFERENCE TO RELATED APPLICATIONS

This application is the national phase entry of International Application PCT/CN2017/103980, filed on Sep. 28, 2017, which is based upon and claims priority to Chinese Patent Application No. 201610880511.6, filed on Sep. 30, 2016, the entire contents of which are incorporated herein by reference.

### TECHNICAL FIELD

The disclosure relates to the field of engines, more particularly to a combustion control method and a combustion control system with variable excess air coefficient for gasoline engine.

### BACKGROUND

Homogeneous charging compression ignition (HCCI) control technology, which realizes low temperature lean combustion by controlling intake air temperature and premixed compression ignition combustion method, effectively improves effective thermal efficiency of the engine and meanwhile reduces pollutant emissions. However, it is difficult to precisely control the intake air temperature. Furthermore, as the engine load increases, the intake air temperature has much greater influence on the compression ignition and even a tiny variation of the temperature will lead to big changes during compression ignition, which may finally result in that the combustion phasing and heat release rate of HCCI control technology get out of control. Meanwhile, as the engine load increases, the rise rate of combustion pressure sharply increases, and uncontrollable abnormal combustion process such as knocking may occur.

### Technical Problem

In existing gasoline engine combustion control technology, the fuel and the air usually are mixed in stoichiometric air-fuel ratio prior to combustion. Since the excess air coefficient does not change along with engine operating conditions (engine load conditions), the advantage that lean combustion effectively improves thermal efficiency of the engine cannot be fully realized.

### Technical Solution for Solving the Problem

### SUMMARY

In order to overcome the shortcomings of the prior art, the disclosure aims to provide a combustion control method and a combustion control system with variable excess air coefficient for gasoline engine, which use different excess air coefficients under different operating conditions of the gasoline engine and achieve comprehensive improvement on effective thermal efficiency, power performance and pollutant emission in entire range of gasoline engine operating conditions.

The disclosure provides a combustion control method with variable excess air coefficient for gasoline engine comprising steps as follows:

Monitoring an engine operating condition;

Determining current engine load condition based on the engine operating condition, wherein the engine load conditions include a part load condition, a high load condition, or a full load condition;

Selecting an appropriate excess air coefficient combustion mode in accordance with the current engine load condition; wherein the engine use a lean combustion mode with an excess air coefficient of 1.6˜2.0 when the current engine load condition is the part load condition; the engine use a combustion mode with an excess air coefficient of 1 when the current engine load condition is the high load condition; and the engine use a combustion mode with an excess air coefficient of 0.8˜0.9 when the current engine load condition is the full load condition.

Furthermore, the part load condition is a condition in which the engine operates at 0˜50% rated power, the high load condition is a condition in which the engine operates at 50%-90% rated power, and the full load condition is a condition in which the engine operates at 900/˜100% rated power.

Furthermore, when the current engine load condition is the part load condition, the engine use the lean combustion mode with the excess air coefficient of 1.6˜2.0, in which combustion mode, precisely controlling the fuel supply amount by means of the fuel injection system and precisely controlling the amount of intake fresh air by means of the variable valve system, so as to form a lean mixture with the excess air coefficient of 1.6˜2.0 inside the cylinder and ignite it. Meanwhile, the engine uses Miller cycle in combination with exhaust gas recirculation to lower the combustion temperature inside the engine cylinder and make the combustion temperature inside the engine cylinder lower than 1900K.

Furthermore, controlling the quantity and the temperature of re-circulated exhaust gas after combustion by exhaust gas recirculation in such a manner that the mixture temperature of the lean mixture inside the cylinder with the excess air coefficient of 1.6˜2.0 at the ignition timing equals to quasi self-ignition temperature.

Furthermore, igniting the lean mixture with the excess air coefficient of 1.6˜2.0 by ignition energy greater than 400 MJ.

Furthermore, when the current engine load condition is the high load condition, the engine use the combustion mode with the excess air coefficient of 1, in which combustion mode, precisely controlling the fuel supply amount by means of the fuel injection system and precisely controlling the amount of intake fresh air by means of the variable valve system, so as to form a mixture with the excess air coefficient of 1 inside the cylinder and ignite it. Meanwhile, the engine uses exhaust gas recirculation to adjust the quantity and the temperature of re-circulated exhaust gas so as to realize appropriate combustion.

Furthermore, when the current engine load condition is the full load condition, the engine use the combustion mode with the excess air coefficient of 0.8˜0.9, in which combustion mode, precisely controlling the fuel supply amount by means of the fuel injection system and precisely controlling the amount of intake fresh air by means of the variable valve system, so as to form a rich mixture with the excess air coefficient of 0.8˜0.9 inside the cylinder and ignite it. Meanwhile, the engine can adjust the quantity and the temperature of re-circulated exhaust gas by exhaust gas recirculation, so as to realize appropriate combustion.

Furthermore, the combustion control method with variable excess air coefficient for gasoline engine further comprises a step of controlling the quantity of the re-circulated exhaust gas after combustion by the exhaust gas recirculation, wherein the quantities of the re-circulated exhaust gas under three combustion modes have a relationship as follows: the quantity in lean combustion mode with the excess air coefficient of 1.6˜2.0>the quantity in the combustion mode with the excess air coefficient of 1>the quantity in the combustion mode with the excess air coefficient of 0.8˜0.9.

Furthermore, the combustion control method with variable excess air coefficient for gasoline engine further comprises a step of controlling the temperature of the re-circulated exhaust gas after combustion by the exhaust gas recirculation, wherein the temperatures of the re-circulated exhaust gas under three combustion modes have a relationship as follows: the temperature in lean combustion mode with the excess air coefficient of 1.6˜2.0>the temperature in the combustion mode with the excess air coefficient of 1>the temperature in the combustion mode with the excess air coefficient of 0.8˜0.9.

Furthermore, after catalytic conversion of the exhaust gas to be discharged that is produced by the combustion in the engine, discharging the exhaust gas.

The disclosure further provides a combustion control system with variable excess air coefficient for gasoline engine, which comprises a cylinder block structure, a variable valve system, a fuel injection system, a high energy ignition system, an exhaust gas recirculation system, an operating condition monitoring system, and an engine electronic control unit, wherein the cylinder block structure comprises a cylinder, the variable valve system is configured to control the amount of the fresh air supplied to the cylinder, the fuel injection system is configured to control the amount of the fuel injected into the cylinder, the high energy ignition system comprises a high energy spark plug and is configured for discharge ignition, and the exhaust gas recirculation system is configured to control the quantity and the temperature of re-circulated exhaust gas, wherein:

The engine electronic control unit is electrically connected with the operating condition monitoring system, the variable valve system, the fuel injection system, the high energy ignition system, and the exhaust gas recirculation system, respectively;

The operating condition monitoring system is configured to monitor an engine operating condition and transmit the monitored result to the engine electronic control unit;

Based on the engine operating condition, a current engine load condition can be determined by means of the engine electronic control unit, wherein the engine load conditions include a part load condition, a high load condition, or a full load condition;

By means of the engine electronic control unit, an appropriate excess air coefficient combustion mode can be selected in accordance with the current engine load condition, wherein:

When the current engine load condition is the part load condition, the engine is controlled, by means of the engine electronic control unit, to use the lean combustion mode with an excess air coefficient of 1.6˜2.0;

When the current engine load condition is the high load condition, the engine is controlled, by means of the engine electronic control unit, to use the combustion mode with an excess air coefficient of 1;

When the current engine load condition is the full load condition, the engine is controlled, by means of the engine electronic control unit, to use the combustion mode with an excess air coefficient of 0.8˜0.9.

Furthermore, the operating condition monitoring system may comprise an engine speed monitoring sensor and a power monitoring device.

Furthermore, the exhaust gas recirculation system may comprise an exhaust gas recirculation line, an exhaust gas recirculation control valve, an exhaust gas recirculation intercooler, an exhaust gas bypass return line and a bypass waste gate, wherein the outlet end of the exhaust gas recirculation line is in communication with the intake pipe, and the inlet end of the exhaust gas recirculation line is in communication with the exhaust pipe, the exhaust gas recirculation control valve and the exhaust gas recirculation intercooler are arranged in the exhaust gas recirculation line in series connection, the exhaust gas bypass return line and the exhaust gas recirculation intercooler are arranged in parallel, and the bypass waste gate is arranged in the exhaust gas bypass return line.

Furthermore, the exhaust gas recirculation system is configured to control the quantity of the re-circulated exhaust gas after combustion, wherein the quantities of the re-circulated exhaust gas under three combustion modes have a relationship as follows: the quantity in lean combustion mode with the excess air coefficient of 1.6˜2.0>the quantity in the combustion mode with the excess air coefficient of 1>the quantity in the combustion mode with the excess air coefficient of 0.8˜0.9.

Furthermore, the exhaust gas recirculation system is configured to control the temperature of the re-circulated exhaust gas after combustion, wherein the temperatures of the re-circulated exhaust gas under three combustion modes have a relationship as follows: the temperature in lean combustion mode with the excess air coefficient of 1.6˜2.0>the temperature in the combustion mode with the excess air coefficient of 1>the temperature in the combustion mode with the excess air coefficient of 0.8˜0.9.

Furthermore, the ignition energy of the high energy spark plug can ignite the rich mixture having an excess air coefficient of 0.8˜0.9 and the mixture having an excess air coefficient of 1, and can ignite the lean mixture having an excess air coefficient of 1.6˜2.0.

### Advantages

The above-mentioned combustion control method and combustion control system with variable excess air coefficient for gasoline engine use different excess air coefficient combustion modes in accordance with different operating conditions of the gasoline engine, achieving comprehensive improvement on effective thermal efficiency, power performance and pollutant emission in entire range of gasoline engine operating conditions.

### BRIEF DESCRIPTION OF THE DRAWINGS

FIG. 1 is a schematic structural drawing of a combustion control system with variable excess air coefficient for gasoline engine of the disclosure;

FIG. 2 is a schematic modular diagram of a combustion control system with variable excess air coefficient for gasoline engine of the disclosure;

FIG. 3 is a flowchart illustrating a combustion control method with variable excess air coefficient for gasoline engine of the disclosure.

### DETAILED DESCRIPTION OF THE EMBODIMENTS

In order to further explain the technical solutions of the disclosure that achieve the above objectives as well as the advantages, specific embodiments, structures, features and effects of the disclosure are described in detail hereinafter with reference to the accompanying drawings and preferred embodiments.

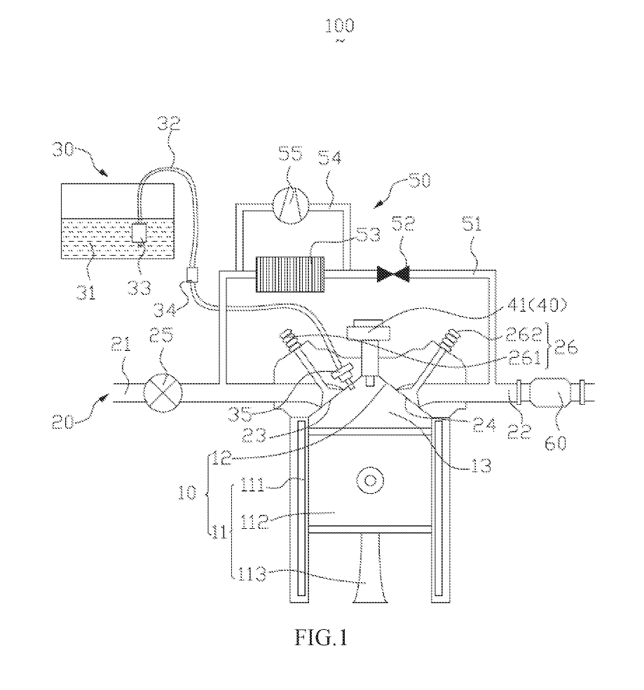

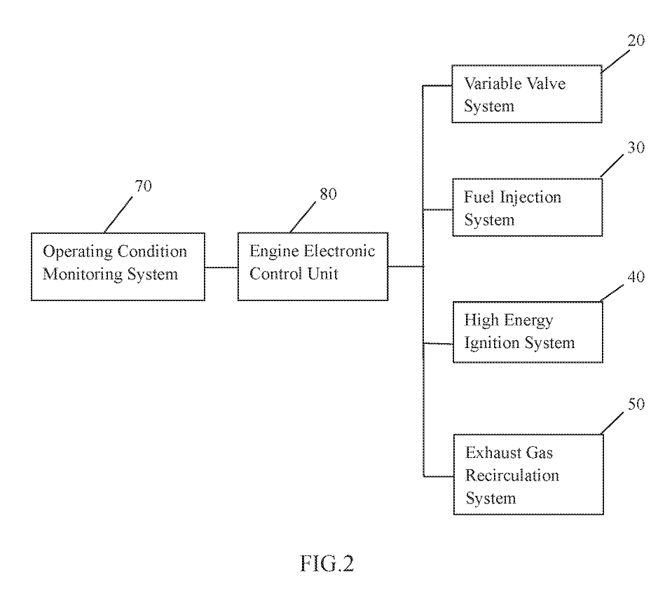

FIG. 1 is a schematic structural drawing of a combustion control system with variable excess air coefficient for gasoline engine of the disclosure, and FIG. 2 is a schematic modular diagram of a combustion control system with variable excess air coefficient for gasoline engine of the disclosure. Referring to FIGS. 1 and 2, a combustion control system 100 with variable excess air coefficient for gasoline engine according to the disclosure comprises a cylinder block structure 10, a variable valve system 20, a fuel injection system 30, a high energy ignition system 40, an exhaust gas recirculation system 50, a catalytic converter 60, an operating condition monitoring system 70, and an engine electronic control unit 80.

The cylinder block structure 10 comprises a cylinder 11 and a cylinder head 12. Herein, the cylinder head 12 is arranged above the hollow cylinder 11, and the cylinder 11 comprises a hollow cylinder body 111, a piston 112 inserted in the cylinder body 111 and movable along an axis of the cylinder body 111, and a connecting rod 113 connected with the piston 112 in an articulated manner. The space between the bottom surface of the cylinder head 12, the top surface of the piston 112 of cylinder 11 and the cylinder body 111 of cylinder 11, forms a combustion chamber 13. Since the present embodiment uses Miller cycle technology, the combustion chamber 13 is a Miller cycle combustion chamber.

The variable valve system 20 is used for precisely controlling the amount of the air that is required for combustion and supplied to the cylinder 11. The variable valve system 20 comprises an intake pipe 21, an exhaust pipe 22, an intake valve 23, an exhaust valve 24, a throttle valve 25, and a variable valve timing mechanism 26. Herein, the intake valve 23 and the exhaust valve 24 are arranged on the cylinder head 12, the intake pipe 21 and the exhaust pipe 22 are arranged outside the cylinder head 12 and are fixedly connected with the cylinder head 12, the intake pipe 21 is in communication with the cylinder 11 through the intake valve 23, and the exhaust pipe 22 is in communication with the cylinder 11 through the exhaust valve 24. Since the present embodiment uses Miller cycle technology, a Miller cycle small lift intake valve is used as the intake valve 23. The variable valve timing mechanism 26 uses variable valve timing (VVT) technology, and can adjust the amount of intake air (exhaust air) by adjusting the valve opening and closing timing and angle of the intake valve 23 (the intake valve 24) according to operation conditions of the engine, so as to optimize the amount of intake air and increase combustion efficiency. The variable valve timing mechanism 26 comprises a variable intake valve actuator 261 arranged at an upper end of the intake valve 23 and configured to control opening and closing of the intake valve 23, and a variable exhaust valve actuator 262 arranged at an upper end of the exhaust valve 24 and configured to control opening and closing of the exhaust valve 24. The throttle valve 25 is arranged on the intake pipe 21 and is configured to control the amount of intake air supplied through the intake pipe 21. The variable intake valve actuator 261, the variable exhaust valve actuator 262, and the throttle valve 25 are electronically controlled actuator components, and in particular, the engine electronic control unit 80 is electrically connected with the variable intake valve actuator 261, the variable exhaust valve actuator 262 and the throttle valve 25, respectively, and controls operations of these components.

The cylinder block structure 10 and the variable valve system 20 work in coordination, and Miller cycle technology is used. Miller cycle realizes a combustion cycle that has an expansion ratio higher than effective compression ratio, improves thermal efficiency of the engine and meanwhile reduces maximum combustion temperature.

The fuel injection system 30 is used for controlling the amount of the fuel injected into the cylinder 11, which system uses gasoline direct injection (GDI) technology. The fuel injection system 30 comprises a fuel tank 31, a fuel delivery pipe 32, a low-pressure fuel delivery pump 33, a high-pressure fuel delivery pump 34, and a high pressure injector 35. Herein, the two ends of the fuel delivery pipe 32 are respectively connected with the fuel tank 31 and the high pressure injector 35, the low-pressure fuel delivery pump 33 is connected with the fuel tank 31, the high-pressure fuel delivery pump 34 is configured to pressurize and deliver the fuel, the high-pressure fuel delivery pump 34 is arranged on the fuel delivery pipe 32 and is configured to further pressurize the fuel inside of the fuel delivery pipe 32, the high pressure injector 35 is arranged on the cylinder head 12 and used for directly injecting fuel into the cylinder 11, the high pressure injector 35 has a fuel nozzle disposed inside the cylinder 11 (the combustion chamber 13), and the fuel inside the fuel delivery pipe 32 is injected into the cylinder 11 via the fuel nozzle of the high pressure injector 35. The high pressure injector 35 is an electronically controlled actuator component, and in particular, the engine electronic control unit 80 is electrically connected with the high pressure injector 35 and controls its injecting operation.

The fuel injection system 30 and the variable valve system 20 work in coordination, to realize precise control of the amount of intake air and fuel in the cylinder 11, thereby achieving a variable control of engine excess air coefficient.

The high energy ignition system 40 comprises a high energy spark plug 41 and a high energy discharge power supply (not shown) for providing electrical energy to the high energy spark plug 41. The high energy spark plug 41 is arranged on the cylinder head 12, and it has an ignition end disposed inside the combustion chamber 21. The ignition energy generated by the high energy spark plug 41 may reach up to 400 MJ. Such ignition energy can not only ignite the rich mixture having an excess air coefficient of 0.8˜0.9 and the mixture having an excess air coefficient of 1, but also can ignite the lean mixture having an excess air coefficient of 1.6˜2.0. The high energy spark plug 41 is an electronically controlled actuator component, and in particular, the engine electronic control unit 80 is electrically connected with the high energy spark plug 41 and controls its discharge ignition.

The exhaust gas recirculation (EGR) system 50 comprises an exhaust gas recirculation line 51, an exhaust gas recirculation control valve 52, an exhaust gas recirculation intercooler 53, an exhaust gas bypass return line 54, and a bypass waste gate 55. Herein, the outlet end of the exhaust gas recirculation line 51 is in communication with the intake pipe 21 downstream of the throttle valve 25, and the inlet end of the exhaust gas recirculation line 51 is in communication with the exhaust pipe 22. The exhaust gas recirculation control valve 52 and the exhaust gas recirculation intercooler 53 are arranged in the exhaust gas recirculation line 51 in series connection. The exhaust gas bypass return line 54 and the exhaust gas recirculation intercooler 53 are arranged in parallel. The bypass waste gate 55 is arranged in the exhaust gas bypass return line 54, and is used for controlling the proportions of the exhaust gas in the exhaust gas recirculation line 51 that passes through and does not pass through the exhaust gas recirculation intercooler 53, so as to precisely control the temperature of re-circulated exhaust gas. The exhaust gas recirculation control valve 52 and the bypass waste gate 55 are electronically controlled actuator components, and in particular, the engine electronic control unit 80 is electrically connected with the exhaust gas recirculation control valve 52 and the bypass waste gate 55 and controls opening and closing of the valves.

In the present embodiment, the exhaust gas recirculation technology is used to control the quantity and the temperature of re-circulated exhaust gas. In particular, a portion of exhaust gas exhausted from the cylinder 11 enters into the exhaust gas recirculation line 51 via the exhaust pipe 22, the amount of the exhaust gas entered into the exhaust gas recirculation line 51 can be controlled by means of the exhaust gas recirculation control valve 52. Furthermore, the exhaust gas in the exhaust gas recirculation line 51 is divided into two portions, one of which is cooled by means of the exhaust gas recirculation intercooler 53, and the other of which bypasses the exhaust gas recirculation intercooler 53, passes through the exhaust gas bypass return line 54 and enters into the exhaust gas recirculation line 51 to mix with the exhaust gas cooled by means of the exhaust gas recirculation intercooler 53, and then re-circulates in the intake pipe 21 to mix with fresh air and then enters into the cylinder 11 again. Herein, the proportions of the exhaust gas passing through the exhaust gas recirculation intercooler 53 and the exhaust gas passing through the exhaust gas bypass return line 54 can be adjusted by the opening and closing of the bypass waste gate 55 in the exhaust gas bypass return line 54, whereby the temperature of the exhaust gas re-circulated to the intake pipe 21 can be precisely controlled.

The exhaust gas recirculation system 50 serves for controlling the quantity and the temperature of re-circulated exhaust gas, and realizing control requirements of the quantity and the temperature of re-circulated exhaust gas under different operating conditions. By means of the exhaust gas recirculation system 50, the temperature and the quantity of re-circulated exhaust gas can be controlled, and thus the temperature of the mixture in the cylinder at the ignition timing can be controlled. After ignition of the mixture, the quantity of the re-circulated exhaust gas directly affects the maximum combustion temperature during combustion. The larger the quantity of the re-circulated exhaust gas, the lower the maximum combustion temperature.

The catalytic converter 60 is arranged in the exhaust pipe 22, and the catalytic converter 60 may be filled with catalysts such as platinum and palladium, so that prior to emission, the exhaust gas, which is exhausted into the exhaust pipe 22 after the combustion inside the cylinder 11 and which contains nitrogen oxides, hydrocarbon, carbon monoxide and so on, can be catalyzed and converted into the gas that meets the environmental protection requirements for emission. Depending on different combustion temperatures and air coefficients, different exhaust gas pollutants may be produced. For example, during low temperature lean combustion, the exhaust gases including hydrocarbon and carbon monoxide may be produced, and during high temperature combustion, the exhaust gases including nitrogen oxides, hydrocarbon and carbon monoxide may be produced. By means of the catalytic converter 60, the exhaust gas pollutants can be converted into the gas that meets the requirements for emission.

Referring to FIG. 2, the engine electronic control unit 80 is electrically connected with the operating condition monitoring system 70, the variable valve system 20, the fuel injection system 30, the high energy ignition system 40, and the exhaust gas recirculation system 50, respectively. The operating condition monitoring system 70 is used for monitoring engine operating conditions such as engine speed and engine power. The operating condition monitoring system may comprise an engine speed monitoring sensor (not shown), a power monitoring device (not shown), and the like, to monitor engine speed, engine power and the like and transmit the monitored results to the engine electronic control unit 80. Then, based on the monitored results, the engine electronic control unit 80 may control the variable valve system 20, the fuel injection system 30, the high energy ignition system 40 and the exhaust gas recirculation system 50 to work.

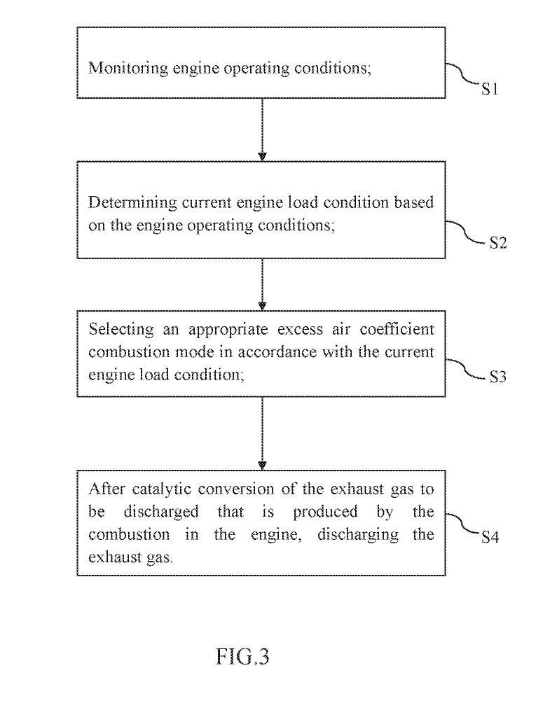

FIG. 3 is a flowchart illustrating a combustion control method with variable excess air coefficient for gasoline engine of the disclosure. Referring to FIG. 3, a combustion control method with variable excess air coefficient for gasoline engine of the disclosure comprises steps as follows.

S1. Monitoring engine operating conditions;

S2. Determining current engine load condition based on the engine operating conditions;

S3. Selecting an appropriate excess air coefficient combustion mode in accordance with the current engine load condition;

S4. After catalytic conversion of the exhaust gas to be discharged that is produced by the combustion in the engine, discharging the exhaust gas.

In the step S1, engine operating conditions can be monitored, for example engine operating parameters including engine speed and engine power can be monitored, to obtain engine operating conditions.

In the step S2, current engine load condition can be determined based on the obtained engine operating conditions, wherein the engine load condition may be a part load condition, a high load condition, or a full load condition. In the present embodiment, the part load condition is a condition in which the engine operates at 0˜50% rated power, the high load condition is a condition in which the engine operates at 50%-90% rated power, and the full load condition is a condition in which the engine operates at 90%-100% rated power.

In the step S3, an appropriate excess air coefficient combustion mode can be selected based on the obtained current engine load condition. In the present embodiment, the engine may use a lean combustion mode with an excess air coefficient of 1.6˜2.0 when the current engine load condition is the part load condition, use a combustion mode with an excess air coefficient of 1 when the current engine load condition is the high load condition, and use a combustion mode with an excess air coefficient of 0.8˜0.9 when the current engine load condition is the full load condition.

In the case that the current engine load condition is the part load condition, the engine may use the combustion mode with the excess air coefficient of 1.6˜2.0. In such combustion mode, the amount of intake air is precisely controlled by means of the variable valve system 20, and the amount of fuel is precisely controlled by means of the fuel injection system 30, so that a lean mixture with the excess air coefficient of 1.6˜2.0 can be formed inside the cylinder 11, and the ignition can be achieved with the ignition energy of the high energy ignition system 40. Meanwhile, the engine uses Miller cycle in combination with exhaust gas recirculation (the exhaust gas recirculation system 50) to lower the combustion temperature inside the engine cylinder 11 and make the combustion temperature inside the engine cylinder 11 lower than 1900K. Furthermore, the quantity and the temperature of re-circulated exhaust gas after combustion can be controlled by exhaust gas recirculation in such a manner that the mixture temperature of the lean mixture inside the cylinder with the excess air coefficient of 1.6˜2.0 at the ignition timing equals to quasi self-ignition temperature, thereby realizing controllable combustion phasing and meanwhile increasing isochoric degree of combustion. Furthermore, the lean mixture with the excess air coefficient of 1.6˜2.0 is ignited by the ignition energy greater than 400 MJ, that is, the ignition energy generated by the high energy ignition system 40 can reach over 400 MJ.

In the case that the current engine load condition is the high load condition, the engine may use the combustion mode with the excess air coefficient of 1. In such combustion mode, the amount of intake air is precisely controlled by means of the variable valve system 20, and the amount of fuel is precisely controlled by means of the fuel injection system 30, so that a mixture with the excess air coefficient of 1 can be formed inside the cylinder 11. Meanwhile, with the exhaust gas recirculation (the exhaust gas recirculation system 50), the engine can adjust the quantity and the temperature of re-circulated exhaust gas to match with the current combustion mode, thereby improving knock suppression.

In the case that the current engine load condition is the full load condition, the engine may use the combustion mode with the excess air coefficient of 0.8˜0.9. In such combustion mode, the amount of intake air is precisely controlled by means of the variable valve system 20, and the amount of fuel is precisely controlled by means of the fuel injection system 30, so that a rich mixture with the excess air coefficient of 0.8˜0.9 can be formed inside the cylinder. Meanwhile, with the exhaust gas recirculation (the exhaust gas recirculation system 50), the engine can adjust the quantity and the temperature of re-circulated exhaust gas to match with the current combustion mode, thereby ensuring available output power of the engine.

In particular, the engine controls the quantity of the re-circulated exhaust gas after combustion by the exhaust gas recirculation, wherein the quantities of the re-circulated exhaust gas under three combustion modes have a relationship as follows: the quantity in lean combustion mode with the excess air coefficient of 1.6˜2.0>the quantity in the combustion mode with the excess air coefficient of 1>the quantity in the combustion mode with the excess air coefficient of 0.8˜0.9.

In particular, the engine controls the temperature of the re-circulated exhaust gas after combustion by the exhaust gas recirculation, wherein the temperatures of the re-circulated exhaust gas under three combustion modes have a relationship as follows: the temperature in lean combustion mode with the excess air coefficient of 1.6˜2.0>the temperature in the combustion mode with the excess air coefficient of 1>the temperature in the combustion mode with the excess air coefficient of 0.8˜0.9.

In the step S4, after catalytic conversion of the exhaust gas to be discharged that is produced by the combustion in the engine, the exhaust gas is discharged. When the current engine load condition is the part load condition, the engine may use the combustion mode with the excess air coefficient of 1.6˜2.0, the exhaust gases to be discharged which is produced by the combustion in the engine include hydrocarbon and carbon monoxide, which exhaust gases are catalyzed and converted by means of the catalytic converter 60 and then discharged. When the current engine load condition is the high load condition, the engine may use the combustion mode with the excess air coefficient of 1, the exhaust gases to be discharged which is produced by the combustion in the engine include hydrocarbon, carbon monoxide, and nitrogen oxides, which exhaust gases are catalyzed and converted by means of the catalytic converter 60 and then discharged. When the current engine load condition is the full load condition, the engine may use the combustion mode with the excess air coefficient of 0.8˜0.9, the exhaust gases to be discharged which is produced by the combustion in the engine include hydrocarbon, carbon monoxide, and nitrogen oxides, which exhaust gases are catalyzed and converted by means of the catalytic converter 60 and then discharged.

The combustion control method with variable excess air coefficient for gasoline engine of the disclosure uses exhaust gas recirculation technology, Miller cycle technology which realizes that in the combustion cycle the expansion ratio is higher than the effective compression ratio, in-cylinder direct injection technology which realizes controllable fuel-injection amount in the cylinder, variable valve system technology which realizes controllable intake air amount in the cylinder, and high energy ignition system technology which realizes controllable combustion phasing, to control the combustion in the engine, and uses the catalytic converter to treat the exhaust gas after combustion. With the exhaust gas recirculation technology, reuse of the exhaust gas can be realized, and the quantity and the temperature of re-circulated exhaust gas can be controlled so as to control the combustion.

As mentioned above, the technical solutions according to the embodiments of the disclosure has advantages as follows. The above-mentioned combustion control method and combustion control system with variable excess air coefficient for gasoline engine use different excess air coefficient combustion modes in accordance with different operating conditions of the gasoline engine, achieving comprehensive improvement on effective thermal efficiency, power performance and pollutant emission in entire range of gasoline engine operating conditions.

The above are merely preferred embodiments of the disclosure, and are not meant to limit the disclosure in any form. The disclosure is intended to cover all changes, equivalent arrangements and various modifications included within the spirit and principle of the disclosure.

### INDUSTRIAL APPLICABILITY

The combustion control method and the combustion control system with variable excess air coefficient for gasoline engine according to the embodiments of the disclosure use different excess air coefficient combustion modes in accordance with different operating conditions of the gasoline engine, achieving comprehensive improvement on effective thermal efficiency, power performance and pollutant emission in entire range of gasoline engine operating conditions.

What is claimed is:

1. A combustion control method with variable excess air coefficient for gasoline engine, characterized in that, it comprises steps of:
monitoring an engine operating condition;
determining a current engine load condition based on the engine operating condition, wherein an engine load condition comprises a part load condition, a high load condition, and a full load condition; and
selecting an appropriate excess air coefficient combustion mode in accordance with the current engine load condition; wherein
a lean combustion mode of the engine with an excess air coefficient of 1.6˜2.0 is used when the current engine load condition is the part load condition;
a combustion mode of the engine with an excess air coefficient of 1 is used when the current engine load condition is the high load condition; and
a combustion mode of the engine with an excess air coefficient of 0.8˜0.9 is used when the current engine load condition is the full load condition.

2. The combustion control method with variable excess air coefficient for gasoline engine according to claim 1, characterized in that, wherein the part load condition is a condition in which the engine operates at 0˜50% rated power, the high load condition is a condition in which the engine operates at 50%˜90% rated power, and the full load condition is a condition in which the engine operates at 90%˜100% rated power.

3. The combustion control method with variable excess air coefficient for gasoline engine according to claim 1, characterized in that, when the current engine load condition is the part load condition, using the lean combustion mode of the engine with the excess air coefficient of 1.6˜2.0, in which combustion mode, a fuel supply amount is precisely controlled by means of a fuel injection system and an amount of intake fresh air is precisely controlled by means of a variable valve system so as to form a lean mixture with the excess air coefficient of 1.6˜2.0 inside the cylinder and ignite it, and meanwhile Miller cycle is used in combination with exhaust gas recirculation of the engine so as to lower combustion temperature inside the engine cylinder and make the combustion temperature inside the engine cylinder lower than 1900K.

4. The combustion control method with variable excess air coefficient for gasoline engine according to claim 3, characterized in that, controlling, by exhaust gas recirculation, a quantity and a temperature of re-circulated exhaust gas after combustion in such a manner that at the ignition timing a mixture temperature of the lean mixture inside the cylinder with the excess air coefficient of 1.6˜2.0 equals to quasi self-ignition temperature.

5. The combustion control method with variable excess air coefficient for gasoline engine according to claim 3, characterized in that, igniting the lean mixture with the excess air coefficient of 1.6˜2.0 by ignition energy greater than 400 MJ.

6. The combustion control method with variable excess air coefficient for gasoline engine according to claim 1, characterized in that, when the current engine load condition is the high load condition, using the combustion mode of the engine with the excess air coefficient of 1, in which combustion mode, a fuel supply amount is precisely controlled by means of a fuel injection system and an amount of intake fresh air is precisely controlled by means of a variable valve system, so as to form a mixture with the excess air coefficient of 1 inside the cylinder and ignite it, and meanwhile, adjusting a quantity and a temperature of re-circulated exhaust gas by exhaust gas recirculation of the engine, so as to realize appropriate combustion.

7. The combustion control method with variable excess air coefficient for gasoline engine according to claim 1, characterized in that, when the current engine load condition is the full load condition, using the combustion mode of the engine with the excess air coefficient of 0.8˜0.9, in which combustion mode, a fuel supply amount is precisely controlled by means of a fuel injection system and an amount of intake fresh air is precisely controlled by means of a variable valve system, so as to form a rich mixture with the excess air coefficient of 0.8˜0.9 inside the cylinder and ignite it, and meanwhile adjusting a quantity and a temperature of re-circulated exhaust gas by exhaust gas recirculation of the engine, so as to realize appropriate combustion.

8. The combustion control method with variable excess air coefficient for gasoline engine according to claim 1, characterized in that, the combustion control method with variable excess air coefficient for gasoline engine further comprises a step of controlling a quantity of the re-circulated exhaust gas after combustion by exhaust gas recirculation, wherein quantities of the re-circulated exhaust gas under three combustion modes have a relationship as follows: the quantity in the lean combustion mode with the excess air coefficient of 1.6˜2.0>the quantity in the combustion mode with the excess air coefficient of 1>the quantity in the combustion mode with the excess air coefficient of 0.8˜0.9.

9. The combustion control method with variable excess air coefficient for gasoline engine according to claim 1, characterized in that, the combustion control method with variable excess air coefficient for gasoline engine further comprises a step of controlling a temperature of the re-circulated exhaust gas after combustion by exhaust gas recirculation, wherein temperatures of the re-circulated exhaust gas under three combustion modes have a relationship as follows: the temperature in the lean combustion mode with the excess air coefficient of 1.6˜2.0>the temperature in the combustion mode with the excess air coefficient of 1>the temperature in the combustion mode with the excess air coefficient of 0.8˜0.9.

10. The combustion control method with variable excess air coefficient for gasoline engine according to claim 1, characterized in that, after catalytic conversion of the exhaust gas to be discharged that is produced by the combustion in the engine, discharging the exhaust gas.

11. A combustion control system with variable excess air coefficient for gasoline engine, characterized in that, it comprises a cylinder block structure, a variable valve system, a fuel injection system, a high energy ignition system, an exhaust gas recirculation system, an operating condition monitoring system, and an engine electronic control unit, wherein the cylinder block structure comprises a cylinder, the variable valve system is configured to control an amount of fresh air supplied to the cylinder, the fuel injection system is configured to control an amount of fuel injected into the cylinder, the high energy ignition system comprises a high energy spark plug and is configured for discharge ignition, and the exhaust gas recirculation system is configured to control a quantity and a temperature of re-circulated exhaust gas;
the engine electronic control unit is electrically connected with the operating condition monitoring system, the variable valve system, the fuel injection system, the high energy ignition system, and the exhaust gas recirculation system, respectively;
the operating condition monitoring system is configured to monitor an engine operating condition and transmit the monitored result to the engine electronic control unit;
the engine electronic control unit is configured to determine a current engine load condition based on the engine operating condition, wherein an engine load condition comprises a part load condition, a high load condition, or a full load condition;
the engine electronic control unit is configured to select an appropriate excess air coefficient combustion mode in accordance with the current engine load condition, wherein:
when the current engine load condition is the part load condition, the engine is controlled, by means of the engine electronic control unit, to use a lean combustion mode with an excess air coefficient of 1.6˜2.0;
when the current engine load condition is the high load condition, the engine is controlled, by means of the engine electronic control unit, to use a combustion mode with an excess air coefficient of 1;
when the current engine load condition is the full load condition, the engine is controlled, by means of the engine electronic control unit, to use a combustion mode with an excess air coefficient of 0.8˜0.9.

12. The combustion control system with variable excess air coefficient for gasoline engine according to claim 11, characterized in that, the operating condition monitoring system comprises an engine speed monitoring sensor and a power monitoring device.

13. The combustion control system with variable excess air coefficient for gasoline engine according to claim 11, characterized in that, the exhaust gas recirculation system comprises an exhaust gas recirculation line, an exhaust gas recirculation control valve, an exhaust gas recirculation intercooler, an exhaust gas bypass return line and a bypass waste gate, wherein the exhaust gas recirculation line has an outlet end in communication with the intake pipe, and the exhaust gas recirculation line has an inlet end in communication with the exhaust pipe, the exhaust gas recirculation control valve and the exhaust gas recirculation intercooler are arranged in the exhaust gas recirculation line in series connection, the exhaust gas bypass return line and the exhaust gas recirculation intercooler are arranged in parallel, and the bypass waste gate is arranged in the exhaust gas bypass return line.

14. The combustion control system with variable excess air coefficient for gasoline engine according to claim 11, characterized in that, the exhaust gas recirculation system is configured to control the quantity of the re-circulated exhaust gas after combustion, wherein quantities of the re-circulated exhaust gas under three combustion modes have a relationship as follows: the quantity in the lean combustion mode with the excess air coefficient of 1.6˜2.0>the quantity in the combustion mode with the excess air coefficient of 1>the quantity in the combustion mode with the excess air coefficient of 0.8˜0.9.

15. The combustion control system with variable excess air coefficient for gasoline engine according to claim 11, characterized in that, the exhaust gas recirculation system is configured to control the temperature of the re-circulated exhaust gas after combustion, wherein temperatures of the re-circulated exhaust gas under three combustion modes have a relationship as follows: the temperature in the lean combustion mode with the excess air coefficient of 1.6˜2.0>the temperature in the combustion mode with the excess air coefficient of 1>the temperature in the combustion mode with the excess air coefficient of 0.8˜0.9.

16. The combustion control system with variable excess air coefficient for gasoline engine according to claim 11, characterized in that, ignition energy of the high energy spark plug is capable of igniting the rich mixture having an excess air coefficient of 0.8˜0.9 and the mixture having an excess air coefficient of 1, and is capable of igniting the lean mixture having an excess air coefficient of 1.6˜2.0.
